(19) United States
(12) Patent Application Publication
(10) Pub. No.: US 2014/0268112 A1
(43) Pub. Date: Sep. 18, 2014

(54) COMBINATION VISUAL FAULT LOCATOR SHORT HAUL DISTANCE TEST MEASUREMENT INSTRUMENT FOR OPTICAL FIBERS

(71) Applicant: GREENLEE TEXTRON INC., (US)

(72) Inventors: Keith Roy Foord, Hamilton (CA); Evangelos Tzannidakis, Burlington (CA); Paul R. Siglinger, Fort Worth, TX (US)

(21) Appl. No.: 13/833,292

(22) Filed: Mar. 15, 2013

(51) Int. Cl. G01M 11/00

(52) U.S. Cl. CPC G01M 11/31
USPC 356/73.1

(57) ABSTRACT

A hand-held instrument uses a red laser to both provide a visual indication to the user of where a fault is present along an optical fiber, and a distance measurement to the user where the fault is present along the optical fiber. The instrument provides a single bulkhead to which the optical fiber is attached to accomplish this dual functionality. The instrument passes a beam of red light into the optical fiber. When the red light encounters a fault in the optical fiber, the red light is emitted from the optical fiber so that the user can visually detect the fault. In addition, the red light is reflected back to the instrument and the instrument determines and outputs a distance measurement at which the fault is located.

### FIELD OF THE INVENTION

The present invention relates to a combination visual fault locator short haul distance test measurement instrument.

### BACKGROUND OF THE INVENTION

An optical time-domain reflectometer (OTDR) is known in the art. An OTDR is an optoelectronic instrument used to characterize an optical fiber. The OTDR emits a series of infrared optical pulses with a low duty cycle into the optical fiber under test. When the infrared light encounters a fault in the optical fiber (such as a break or bend in the optical fiber, or the end of the optical fiber), the infrared light is reflected back to the OTDR. The OTDR has electronic circuitry which calculates the distance to the fault in the optical fiber and outputs a distance measurement, in numeric form, so that the user can locate the fault along the optical fiber. The measurement port on an OTDR is typically one of, or a combination of, 850, 1300, 1310, 1490, 1550 or 1625 nm and is always a pulsed technology.

A measurement device, such as those manufactured by Leica Geosystems, emits a red light beam through air to determine the distance a solid object, such as a wall or a ceiling, is distanced from the measurement device. When the red light encounters the solid object, the red light is reflected back to, and collected by, the measurement device. The measurement device has electronic circuitry which calculates the distance to the solid object from the measurement device, and outputs the distance measurement, in numeric form, to the user.

A Visual Fault Locator (VFL) device is also known in the art. The VFL emits a red light beam from a red laser through an optical fiber. The WI, port is a CW 650 nm source. When the red light encounters a fault in the optical fiber (such as a break or bend in the optical fiber, or the end of the optical fiber), the red light is emitted from the optical fiber at the point of the fault. The user of the VFL device sees the red light and can visually detect where the fault is in the optical fiber.

A combination device which includes OTDR functionality and VFL functionality is also known in the art. The combination device has a red laser connected to a first bulkhead connector on the device which can be connected to the optical fiber to perform a visual fault location. The combination device also has an infrared laser connected to a second bulkhead connector on the device which can be connected to the optical fiber to perform distance measurement. The user must manually connect the optical fiber under test to each bulkhead connector in turn in order to obtain a visual reading and the measurement reading from the combination device. This is time consuming and can result in an increased chance of damage to the optical fiber since it is being handled twice.

One issue with use of a red laser is that the red light only travels a short distance in single mode fiber. Therefore, a red laser can only be used for short haul/distances. Infrared lasers, however, are very costly.

There is a need for a device which enables a user to perform both functions, while being cost effective. A combination visual fault locator short haul distance test measurement instrument is provided herein which provides improvements to the existing devices and which overcomes the disadvantages presented by the prior art. Other features and advantages will become apparent upon a reading of the attached specification, in combination with a study of the drawings.

### SUMMARY OF THE INVENTION

A hand-held instrument uses a red laser to both provide a visual indication to the user of where a fault is present along an optical fiber, and a distance measurement to the user where the fault is present along the optical fiber. The instrument provides a single bulkhead to which the optical fiber is attached to accomplish this dual functionality. The instrument passes a beam of red light into the optical fiber. When the red light encounters a fault in the optical fiber, the red light is emitted from the optical fiber so that the user can visually detect the fault. In addition, the red light is reflected back to the instrument and the instrument determines and outputs a distance measurement at which the fault is located.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a perspective view of an instrument which incorporates the features of the present invention;

FIG. 2 is an enlarged perspective view of an optical fiber which can be tested by the instrument of FIG. 1; and replacement

FIG. 3 is a block diagram of the components of the instrument and an optical fiber.

### DETAILED DESCRIPTION OF THE ILLUSTRATED EMBODIMENTS

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein. Therefore, unless otherwise noted, features disclosed herein may be combined together to form additional combinations that were not otherwise shown for purposes of brevity.

A hand-held combination visual fault locator short haul distance test measurement instrument 20 is disclosed. The instrument 20 is a cost effective tool for a technician to carry so that the technician can quickly and easily determine both visually and with a digital readout where a break, a lossy area of an optical fiber 22 is located or how long an optical fiber cable is. With the current state of the art, the technician needs to carry two devices: a VFL device, and a Fault Locator/OTDR device. Carrying two devices is not practical since it is not economically feasible for every technician to have an OTDR.

The instrument 20 uses a red laser which emits a red light to both provide a visual indication to the user of where a fault is present along the optical fiber 24, and to provide a numeric distance measurement to the user where the fault is present along the optical fiber 24. The instrument 20 includes a housing 28 having a red laser light source 26 provided therein for emitting the red laser light, a sensor system 30 provided therein, a display 32 on said housing 28, an activator 34, such as a button that can be depressed by the user, for activating the sensor system 30, and a single bulkhead connector 36 extending from the housing 28. The bulkhead connector 36 is connected to the laser light source 26 and to the sensor system 30. The instrument 20 can be easily carried in the hand of user, thus making the instrument portable. The laser light source 26 emits a 650 nm laser signal. The use of a red laser is much more cost effective than using an infrared laser, or the combination device which includes an OTDR and a VFL device discussed in the background section.

The sensor system 30 is partially described herein in terms of functional block components and processing steps. It should be appreciated that such functional blocks may be realized by any number of hardware and/or software components configured to perform the specified functions. For example, the sensor system 30 may employ various integrated circuit or optical components, e.g., memory elements, processing elements, logic elements, look-up tables, and the like, which may carry out a variety of functions under the control of one or more microprocessors or other control devices. Similarly, the software elements of the present invention may be implemented with any programming or scripting language, with various algorithms being implemented with any combination of data structures, objects, processes, routines or other programming elements. Further, it should be noted that the instrument 20 could employ any number of conventional techniques for electronics configuration, optical configuration, signal processing, and data processing. For the sake of brevity, conventional electronics, optics, software development and other functional aspects of the present invention, and components of the individual operating systems of the invention, may not be described in detail herein.

With reference to FIG. 3, the sensor system 30 includes a splitter 38, a path 40 extending from the laser light source 26 to the splitter 38, a path 42 extending from the splitter 38 to the bulkhead connector 36, a termination 44 connected to the splitter 38 along path 46, an avalanche photo diode 48 connected to the splitter 38 along path 50, and a suitable electronic system 52 connected to the avalanche photo diode 48 along path 54. The electronic system 52 is also electrically coupled to the laser light source 26 via path 54/56 to cause the laser light source 26 to emit red light upon activation by the activator 34. A power source 58, such as a battery and a high voltage power supply derived from that battery, is provided in the housing 28 and powers the electronic system 52 and biases the avalanche photo diode 48. The optical fiber 24 is coupled via its ferrule 25 to the sensor system 30 at bulkhead connector 36. The optical fiber 24 can be a single optical fiber as shown, a plurality of bunched optical fibers, or a ribbon-type optical fiber. Paths 40, 42, 46, 50 interconnecting the various components in the sensor system 30 may be any sort of optical fiber capable of directing light between the components.

The splitter 38 splits the red light from the laser light source 26 into two light beams, which travel on paths 42 and 26. The light beam traveling along path 42 is coupled to the bulkhead connector 36 and the light beam traveling along path 46 is coupled to the termination 44. Terminations are known in the art and are used to attenuate light so as to minimize the amount of reflection of the light along a path, such as path 46. The splitter 38 can be hardwired or can be an integrated optics chip, as is known in the art. For example, the splitter 38 may be formed by stripping the cladding off of each of fibers, placing the two fiber cores together, and melting the cores together with the application of heat and/or tensile pressure. Red light entering splitter 38 from the laser light source 26 is divided into two portions, with each portion exiting the splitter 38 on the opposite side of the splitter 38. Light entering splitter 38 from the bulkhead connector 36 is divided into two portions, with each portion exciting the splitter 38 on the opposite side of the splitter 38. It is possible for the splitter 38 to split the light in approximately equal portions, or non-equal portions.

The avalanche photo diode 48 conducts an electric current in response to the intensity of the reflected light. The electronics system 52 may include circuitry capable of detecting the amplitude or intensity of light emanating from the optical fiber 24 or other characteristics of the optical fiber 24, and may include circuitry or other components to generate a digital or analog signal. The electronic system 52 includes processing circuitry suitable for calculating a distance measurement and displaying this output on display 32. The electronic system 52 can be a microprocessor, a microcontroller, a digital signal processor, a programmed array logic (PAL), an application specific integrated circuit (ASIC), or other such device. The electronic system 52 suitably includes a digital signal processor, which will typically be provided in conjunction with an associated memory and circuitry for addressing, input/output.

Upon activation of the instrument 20 using the activator 34, such as by depressing the button, the sensor system 30 activates the laser light source 26 and red light is generated by the laser light source 26. The red light from the laser light source 26 translates along path 40 to the splitter 38, along path 42 to the bulkhead connector 36 and into the optical fiber 24. When the red light encounters a fault in the optical fiber 24 (such as a break or bend in the optical fiber 24, or the end of the optical fiber 24), the red light is emitted from the optical fiber 24 at the fault point. Assuming the fault is not buried within another structure, such as a wall or ceiling, the user of the instrument 20 visually detects the red light and identifies where the fault is in the optical fiber 24. The red light appears to be continuously emitted from the fault location to the user.

When the red light from the laser light source 26 encounters a fault in the optical fiber 24, the red light is reflected back through the bulkhead connector 36, along path 42, through splitter 38 and is separated by the splitter 38 into two light beams traveling on paths 40 and 50. The light beam traveling along path 40 is returned to the laser light source 26. The light beam traveling along path 50 is coupled to the avalanche photo diode 48. The electronic system 52 determines the amount of time it took for the laser light to travel from the light source 26, to the fault and to return to the avalanche photo diode 48. The electronic system 52 uses this information to output a distance measurement via display 32 to the user as to where the fault occurs along the optical fiber 24.

Therefore, the present invention provides a combination visual fault locator short haul distance test measurement instrument 20 which uses the same red laser light to provide both: 1) a visual indication of where the fault is, and 2) the distance measurement at where the fault is. With regard to the combination device discussed in the background section, a significant cost savings is realized by the instrument 20 in that only a single laser source 26 and bulkhead connector 36 are provided in the present invention. With regard to the prior art OTDR discussed in the background section, added functionality is provided by the instrument 20 by providing a red light source, as opposed to the non-visual infrared light source.

While a preferred embodiment of the present invention is shown and described, it is envisioned that those skilled in the art may devise various modifications of the present invention without departing from the spirit and scope of the appended claims.

What is claimed is:

1. An assembly comprising:
an optical fiber; and
a hand-held instrument comprising:
a housing,
a red laser light source within said housing, said red laser light source capable of emitting a beam of red light,
a display provided on said housing,
a sensor system provided within said housing, said sensor system connected to said laser light source and to said display, and
a single bulkhead connector extending from the housing, said bulkhead connector connected to said laser light source and to said sensor system,
wherein said optical fiber is connected to said bulkhead, and said sensor system is used to activate said red laser light source to pass the beam of red light into said optical fiber, and wherein when said red light encounters a fault in the optical fiber, said red light is emitted from said optical fiber, and said red light is reflected hack to said sensor system which determines and outputs a distance measurement via said display at which the fault is located.

2. The assembly defined in claim 1, wherein said sensor system includes a splitter connected to said bulkhead connector, an avalanche photo diode connected to said splitter, and an electronic system connected to said avalanche photo diode.

3. The assembly defined in claim 1, wherein said sensor system includes a termination connected to said splitter.

4. The assembly defined in claim 1, wherein said red laser light source is a 650 nm laser.

5. A method comprising:
connecting an optical fiber to a bulkhead on an instrument;
activating said instrument to emit a red laser light into said optical fiber, said red laser light being a beam of red light, wherein when said red light encounters a fault in the optical fiber, said red light is emitted from said optical fiber, and said red light is also reflected back to said instrument,
said instrument determining and outputting a distance measurement via at which the fault is located.

6. The method defined in claim 5, wherein said instrument includes a display and said distance measurement is displayed on said display.

7. The method defined in claim 6, wherein said instrument is activated by depressing a button.

8. The method defined in claim 6, wherein said red laser light is emitted from a 650 nm laser.
